(19) United States
(12) Patent Application Publication
(10) Pub. No.: US 2004/0086432 A1
(43) Pub. Date: May 6, 2004

(54) Reformer, systems utilizing the reformer, and methods for operating the systems

(76) Inventors: William J. LaBarge, Bay City, MI (US); Joachim Kupe, Davisburg, MI (US); Galen B. Fisher, Bloomfield Hills, MI (US); John Edward Kirwan, Troy, MI (US); Kenneth Mark Rahmoeller, West Bloomfield, MI (US)

Correspondence Address: Vincent A. Cichosz, Delphi Technologies, Inc., M/C 480-410-202, P.O. Box 5052, Troy, MI, 48007-5052, US

(21) Appl. No.: 10/284,973

(22) Filed: Oct. 31, 2002

(51) Int. Cl. B01D 50/00; F01N 3/00; F01N 3/10; B01D 53/34

(52) U.S. Cl. 422/177; 60/286; 60/301

(57) ABSTRACT

Disclosed herein are various embodiments of systems (including vehicle systems and fuel cell systems), as well as reformers and methods for operating the systems. In one embodiment, the reformer comprises: a support comprising a reforming catalyst and a hexaaluminate comprising a crystal stabilizer disposed in a hexaaluminate crystal structure. Meanwhile, one embodiment of the system comprises: a device selected from the group consisting of an engine, a fuel cell, and combinations thereof, and the reformer.

### TECHNICAL FIELD

The disclosure relates to a reformer, and especially relates to a reformer comprising a hexaaluminate.

### BACKGROUND OF THE INVENTION

Alternative transportation fuels have been represented as enablers to reduce toxic emissions in comparison to those generated by conventional fuels. At the same time, tighter emission standards and significant innovation in catalyst formulations and engine controls has led to dramatic improvements in the low emission performance and robustness of gasoline and diesel engine systems. This has certainly reduced the environmental differential between optimized conventional and alternative fuel vehicle systems. However, many technical challenges remain to make the conventionally fueled internal combustion engine a nearly zero emission system having the efficiency necessary to make the vehicle commercially viable.

Alternative fuels cover a wide spectrum of potential environmental benefits, ranging from incremental toxic and carbon dioxide (CO₂) emission improvements (reformulated gasoline, alcohols, LPG, etc.) to significant toxic and CO₂ emission improvements (natural gas, DME, etc.). Hydrogen is clearly the ultimate environmental fuel, with potential as a nearly emission free internal combustion engine fuel (including CO₂ if it comes from a non-fossil source). Unfortunately, the market-based economics of alternative fuels, or new power train systems, are uncertain in the short to mid-term.

The automotive industry has made very significant progress in reducing automotive emissions in both the mandated test procedures and the “real world”. This has resulted in some added cost and complexity of engine management systems, yet those costs are offset by other advantages of computer controls: increased power density, fuel efficiency, drivability, reliability and real-time diagnostics.

Future initiatives to require zero emission vehicles appear to be taking us into a new regulatory paradigm where asymptotically smaller environmental benefits come at a very large incremental cost. Yet, even an “ultra low emission” certified vehicle can emit high emissions in limited extreme ambient and operating conditions or with failed or degraded components. One approach to addressing the issue of emissions is the employment of fuel cells, particularly solid oxide fuel cells (SOFC), in an automobile. A fuel cell is an energy conversion device that generates electricity and heat by electrochemically combining a gaseous fuel, such as hydrogen, carbon monoxide, or a hydrocarbon, and an oxidant, such as air or oxygen, across an ion-conducting electrolyte. The fuel cell converts chemical energy into electrical energy. SOFCs are constructed entirely of solid-state materials, utilizing an ion conductive oxide ceramic as the electrolyte. An electrochemical cell in a SOFC comprises an anode and a cathode with an electrolyte disposed therebetween. The oxidant passes over the oxygen electrode (cathode) while the fuel passes over the fuel electrode (anode), generating electricity, water, and heat.

In a typical SOFC, a fuel flows to the anode where it is oxidized by oxygen ions from the electrolyte, producing electrons that are released to the external circuit, and mostly water and carbon dioxide are removed in the fuel flow stream. At the cathode, the oxidant accepts electrons from the external circuit to form oxygen ions. The oxygen ions migrate across the electrolyte to the anode. The flow of electrons through the external circuit provides for consumable or storable electricity. However, each individual electrochemical cell generates a relatively small voltage. Higher voltages are attained by electrically connecting a plurality of electrochemical cells in series to form a stack.

The long term successful operation of a fuel cell depends primarily on maintaining structural and chemical stability of fuel cell components during steady state conditions, as well as transient operating conditions such as cold startups and emergency shut downs. The support systems are required to store and control the fuel, compress and control the oxidant and provide thermal energy management. A SOFC can be used in conjunction with a reformer that converts a fuel to hydrogen and carbon monoxide (the reformate) usable by the fuel cell. Three types of reformer technologies are typically employed (steam reformers, dry reformers, and partial oxidation reformers) to convert hydrocarbon fuel (methane, propane, natural gas, gasoline, etc) to hydrogen using water, carbon dioxide, and oxygen, respectfully, with byproducts including carbon dioxide and carbon monoxide, accordingly. These reformers operate at high temperatures (e.g., greater than or equal to about 1,200° C. It is noted that a new reformer catalyst is operated at about 850° C., after a few hours at about 1,100° C., and by 1,000 hours of usage, at about 1,200° C.; with a durability of greater than or equal to about 10,000 hours). At lower temperatures, e.g., during start-up, deposition of carbon (or soot) upon the catalyst can adverse the reformer efficiency and reduce reformer life. Major requirements for the reformers are rapid start, dynamic response time, fuel conversion efficiency, size, and weight.

### SUMMARY OF THE INVENTION

Disclosed herein are various embodiments of systems (including vehicle systems and fuel cell systems), as well as reformers and methods for operating the systems. In one embodiment, the reformer comprises: a support comprising a reforming catalyst and a hexaaluminate comprising a crystal stabilizer disposed in a hexaaluminate crystal structure. Meanwhile, one embodiment of the system comprises: a device selected from the group consisting of an engine, a fuel cell, and combinations thereof, and the reformer.

A fuel cell system and method for reforming fuel are disclosed herein. In one embodiment, the system comprises: a fuel cell, and a reformer disposed in fluid communication with the fuel cell, the reformer comprising a housing and a support disposed within the housing, wherein the support comprises a catalyst and a hexaaluminate comprising a catalyst stabilizer disposed in a hexaaluminate crystal structure. One embodiment of a method for reforming a fuel comprises: directing fuel into the reformer and reforming at least a portion of the fuel.

One embodiment of the method for operating a vehicle comprises: starting an engine, directing fuel to the reformer to form hydrogen and directing at least a first portion of the hydrogen to an exhaust emission control device.

Similarly, one embodiment of the method for operating a system, comprises: directing fuel to the reformer to produce hydrogen and directing at least a first portion of the hydrogen to a fuel cell.

The above-described and other features will be appreciated and understood by those skilled in the art from the following detailed description, drawings, and appended claims.

### DESCRIPTION OF THE PREFERRED EMBODIMENT

Reformers typically comprise a housing disposed around a substrate comprising a catalyst. Disposed between the housing and the substrate can be a retention material. The device can comprise part of a fuel cell system or merely a vehicle system. The fuel cell system comprises a fuel cell stack disposed downstream from the reformer, which is downstream from a fuel source. The vehicle system comprises an engine (e.g., gasoline, diesel, or the like), with the reformer disposed downstream of the engine, and preferably disposed upstream of an optional, close coupled exhaust emission treatment device (e.g., catalytic converters, evaporative emissions devices, scrubbing devices (e.g., hydrocarbon, sulfur, and the like), particulate filters/traps, adsorbers/absorbers, non-thermal plasma reactors, and the like, as well as combinations comprising one or more of the foregoing devices). Since the reformer can attain temperatures of up to about 1,200° C. or greater during operation, the reformer substrate typically comprises a ceramic often in the form of a foam, or the like. The catalyst on the ceramic foam is a precious metal or similar catalyst on a stabilized oxide support.

Different types of electrochemical cell systems exist; including solid oxide fuel cells and proton exchange membrane fuel cells (PEM), with tubular and planar configurations. Reference to a particular cell configuration and components for use within a particular cell configuration are intended to also represent similar components in other cell configurations where applicable.

Generally, the system may comprise at least one fuel cell, an engine, one or more heat exchangers, and optionally, one or more compressors, an exhaust turbine, a catalytic converter (or other exhaust treatment device), preheating device, plasmatron, electrical source (e.g., battery, capacitor, motor/generator, turbine, and the like, as well as combinations comprising one or more of the foregoing electrical sources), and connections, wiring, control valves, and a multiplicity of electrical loads, including, but not limited to, lights, resistive heaters, blowers, air conditioning compressors, starter motors, traction motors, computer systems, radio/stereo systems, and a multiplicity of sensors and actuators, and the like, as well as other components.

To facilitate the production of electricity by the fuel cell, a direct supply of simple fuel, e.g., hydrogen, carbon monoxide, and/or methane is preferred. However, concentrated supplies of these fuels are generally expensive and difficult to supply. Therefore, the fuel utilized can be obtained by processing a more complex fuel source. The actual fuel utilized in the system is typically chosen based upon the application, expense, availability, and environmental issues relating to the fuel. Possible fuels include hydrocarbon fuels, including, but not limited to, liquid fuels, such as gasoline, diesel, ethanol, methanol, kerosene, and others; gaseous fuels, such as natural gas, propane, butane, and others; and “alternative” fuels, such as hydrogen, biofuels, dimethyl ether, and others; synthetic fuels, such as synthetic fuels produced from methane, methanol, coal gasification or natural gas conversion to liquids, and combinations comprising one or more of the foregoing methods, and the like; as well as combinations comprising one or more of the foregoing fuels. The preferred fuel is typically based upon the type of engine employed, with lighter fuels, i.e., those which can be more readily vaporized and/or conventional fuels which are readily available to consumers, generally preferred.

Furthermore, the fuel for the fuel cell can be processed in a reformer. A reformer generally converts one type of fuel to a fuel usable by the fuel cell (e.g., hydrogen). Mainly two types of reformer technologies are employed, steam reformers, which employ exothermic reaction, and partial oxidation reformers, which employ an endothermic reaction. Steam reformer technology is generally employed for converting methanol to hydrogen. Partial oxidation reformers are generally employed for converting gasoline to hydrogen. Typical considerations for the reformers include rapid start, dynamic response time, fuel conversion efficiency, size, and weight.

As with an exhaust treatment device, a reformer treats a gaseous stream to convert at least one component of the stream; in the case of a reformer, a hydrocarbon is converted to hydrogen or to a less complex hydrocarbon. Similarly, as with an exhaust treatment device, the reformer comprises a housing disposed about a catalyst bed, with an inlet and an outlet. The catalyst bed comprises a substrate with catalyst disposed on or throughout the substrate.

Various substrate materials can be employed for use in the catalyst bed. Generally, the materials are capable of withstanding exposure fuel pulsations, abrasive wear, thermal shock, poisons, sintering aids, hydrocarbons, carbon monoxide, carbon dioxide, and other fuel components, impurities, and reaction products. Some possible substrate materials include ceramics, metal oxides (e.g., alumina, and the like), and the like, and combinations comprising one or more of the foregoing materials. The substrate can be in the form of foils, porous structures (e.g., sponges, beads, irregular or regular shaped objects (e.g., saddles and other packed bed components), monoliths (e.g., a honeycomb structure, and the like), and the like, as well as combinations comprising one or more of the foregoing forms, comprising any geometry employed for substrates in reformers. For example, the substrate can be alumina, zirconium toughened aluminum, silicon carbide

Hexaaluminates are crystalline, porous structures that are able to withstand high temperatures (e.g., temperatures less than or equal to about 1,350° C.) without sintering, thereby making them an ideal candidate as a catalyst in reformers. Even at temperatures of up to about 1,600° C., hexaaluminates can have a surface area of 20 square meters per gram (m²/g). A hexaaluminate is a very specific compound with a specific crystal structure, e.g., with a barium ion aligned in the C-axis of the hexaaluminate crystal structure. With a crystal stabilizer, the C-axis of the hexaaluminate is restrained such that the structure cannot collapse even at very high temperature. For example, barium hexaaluminate is one very specific compound (BaAl₁₂O₁₉), with a barium content being 17.9 wt %. In contrast to hexaaluminates, aluminates are not specific structures, they are random mixtures; e.g., barium aluminates have barium in randomized locations, not necessarily in the C-axis. Barium aluminate describes many compounds such as, but not limited to, BaAl₂0₄. The barium content of a barium aluminate can range from less than about 1 wt % to more than about 60 wt %.

A crystal stabilizer is disposed within the hexaaluminate crystalline structure to inhibit crystal collapse at high temperatures. The crystal stabilizer can comprise Group Ia metals, Group IIa metals, rare earth metals, active metals (e.g., Group VIII metals, precious metals, and the like), and the like, as well as combinations comprising one or more of the foregoing crystal stabilizers. Group Ia stabilized hexaaluminates, in order of preference of the crystal stabilizers, may comprise barium (forming, e.g., BaAl₁₂O₁₉), strontium (forming, e.g., SrAl₁₂O₁₉) and magnesium (forming, e.g., MgAl₁₂O₁₉). Some rare earth stabilized hexaaluminates, in order of preference of the crystal stabilizers, may comprise lanthanum (forming, e.g., LaAl₁₁O₁₈), praseodymium (forming, e.g., PrAl₁₁O₁₈), and cerium (forming, e.g., CeAl₁₁O₁₈). An example of a combination of Group IIa and rare earths stabilizers particularly includes barium-lanthanum (forming, e.g., Ba_{0.5}La_{0.7}Al₁₁O₁₈) and strontium-lanthanum (forming, e.g., Sr_{0.8}La_{0.2}Al₁₁O₁₈). Other possible stabilizers include hafnium, neodymium, scandium, yttrium, zirconium, and the like. Combinations of one or more of any of the above crystal stabilizers can also be employed.

The base metal activated and stabilized hexaaluminates, may include the base metals manganese, nickel, iron, and the like, rare earths, and Group Ia stabilizers, and combinations comprising one or more of the foregoing base metals. For example, in order of preference, lanthanum-manganese (forming, e.g., LaMnAl₁₁O₁₉), barium-manganese (forming, e.g., BaₓMn₁₋ₓAl₁₂O₁₉), lanthanum-nickel (forming, e.g., LaNiAl₁₁O₁₉), barium-nickel (forming, e.g., BaₓNi₁₋ₓA₁₁O₁₉), lanthanum-iron (forming, e.g., LaFeAl₁₁O₁₉), and barium-iron (forming, e.g., BaₓFe₁₋ₓAl₁₂O₁₉).

The precious metal activated and stabilized hexaaluminates may include precious metals (e.g., platinum, palladium, rhodium, ruthenium, iridium, gold, and silver, and the like), base metals (e.g., manganese, nickel, iron, and the like), and the like, and combinations comprising one or more of the foregoing catalyst stabilizers.

Not to be limited by theory, it is believed that the crystal stabilizer is disposed in a particular location within the crystalline structure (i.e., the C-axis), such that, upon heating, the crystal stabilizer inhibits destabilization of the crystalline structure (e.g., collapsing of the crystalline structure). Consequently, crystal stabilizers having larger atomic sizes are preferred. Preferably, the crystal stabilizer comprises barium, strontium, and/or lanthanum with barium especially preferred.

It should be noted that the crystal stabilizer is introduced into the hexaaluminate crystalline structure as an organometallic. When it reacts with the hexaaluminate, the crystal stabilizer(s) enters the crystalline structure and bonds such that it shares oxygen with the crystal structure. Preferably, the crystal stabilizer is present in the crystalline structure in an amount of about 0.01 weight percent (wt %) to about 19 wt %, based upon the total weight of the stabilized hexaaluminate.

Depending upon the crystal stabilizer incorporated into the crystalline structure, avoidance of some materials can be advantageous. Some materials, which may be avoided, include zinc, titanium, silicon, niobium, boron, germanium and phosphorus. These materials migrate to the surface of the precious metals and inhibit the ability of the exhaust gasses to reach the active metal sites. In some cases, e.g., when ruthenium is incorporated into the crystalline structure, nickel, cobalt, iron, manganese, chromium, and copper are also avoided. Rhodium is preferred for its hydrogen formation activity. Base metals such as nickel, cobalt, iron, manganese, chromium, and copper “poison” or reduce such activity of the rhodium, ruthenium. When base metals are included, such as manganese hexaaluminate, ruthenium is not included into the structure. Furthermore, support-fluxing agents such as lithium, sodium, potassium, rubidium, cesium, and beryllium, can be avoided. Alkaline earths enable the loss of surface area of the hexaaluminate structure.

The hexaaluminate can be formed in various fashions by combining the crystal stabilizer (in the form of an organometallic) with an organometallic aluminum, with precursors (e.g., organometallics) that form the hexaaluminate at low temperatures (e.g., less than or equal to about 500° C.) preferred. Possible organometallic aluminums include aluminum isopropoxide, aluminum hydroxide, aluminum methoxide, aluminum n-butoxide, aluminum ethoxide, and the like, as well as combinations comprising one or more of the foregoing compounds, with aluminum isopropoxide preferred. Possible crystal stabilizer organometallics comprise crystal stabilizer 2-ethylhexanoates, crystal stabilizer isopropoxides, and the like, as well as combinations comprising one or more of the foregoing organometallics. For example, the crystal stabilizer organometallic can be lanthanum 2-ethylhexanoate, barium 2-ethylhexanoate, strontium 2-ethylhexanoate, manganese 2-ethylhexanoate, cobalt 2-ethylhexanoate, iron 2-ethylhexanoate, cerium 2-ethylhexanoate, ruthenium 2-ethylhexanoate, palladium 2-ethylhexanoate, and the like, as well as combinations comprising one or more of the foregoing organometallics. Examples of preferred hexaaluminates include rhodium hexaaluminate, barium hexaaluminate, strontium hexaaluminate, lanthanum hexaaluminate, and ruthenium-barium hexaaluminate.

For example, hexaaluminates can be formed by mixing aluminum isopropoxide (soluble organometallic aluminum) and lanthanum isopropoxide (soluble organometallic crystal stabilizer) in a solvent (e.g., water). The mixed material can be fired to 500° C. to form the hexaaluminates crystalline structure. These hexaaluminates (e.g., lanthanum hexaaluminates) will maintain a surface area of greater than or equal to about 100 meters squared per gram (m²/g) at 1,300° C., with greater than or equal to about 125 m²/g readily attained, and even greater than or equal to about 150 m²/g possible.

Although hexaaluminates can be formed by fusion, e.g., combining inorganic materials at very high temperatures (e.g., greater than or equal to about 1,350° C.), these hexaaluminates are not preferred due to their low surface areas, e.g., less than or equal to about 20 m²/g. For example, a hexaaluminate can be formed by reacting manganese oxide and aluminum oxide at greater than or equal to about 1,400° C. The manganese oxide crystal structure and the aluminum oxide crystal structure are already formed. To insert manganese into the aluminum oxide structure and change that structure to a hexaaluminate structure, a great deal of energy is required. The temperature, which supplies that energy, also reduces the pore structure and the surface area. These hexaaluminates, because of the high temperature of formation, have surface areas less than 20 m²/g.

Once the stabilized hexaaluminate is formed, it can be optionally be disposed on a substrate, preferably in combination with a catalyst stabilizer and optionally a catalyst for reforming fuel. The catalyst stabilizer preferably comprises a material that will not dissolve into the hexaaluminate structure upon exposure to high temperatures (e.g., the temperature at which the hexaaluminate will be employed), that will not react with the hexaaluminate, and that will substantially remain in the grain boundaries (e.g., will inhibit hexaaluminate particles from agglomerating on the substrate). Possible metals for the catalyst stabilizer include strontium, barium, hafnium, scandium, zirconium, yttrium, cerium, lanthanum, praseodymium, neodymium, and the like, as well as alloys and combinations comprising one or more of the foregoing metals. Preferred catalyst stabilizers include zirconium oxide, bariumzirconium oxide, barium aluminate, as well as combinations comprising one or more of the foregoing catalyst stabilizers. For example a preferred catalyst stabilizer comprises about 100 wt % zirconium oxide (based upon the total weight of the catalyst stabilizer).

Although the catalyst can be deposited onto the hexaaluminate in combination with the catalyst stabilizer as the hexaaluminate is disposed onto the substrate, the catalyst is preferably subsequently disposed on the coated substrate (or directly onto the hexaaluminate if it is the substrate), with deposition after calcination of the coated substrate particularly preferred. Various metals capable of reforming hydrogen can be employed as the catalyst, such as precious metals, with platinum, palladium, rhodium, ruthenium, iridium, gold, and silver, as well as combinations comprising one or more of these catalysts preferred. One preferred catalyst coated substrate comprises about 0.01 wt % to about 35 wt % rhodium, based upon the total weight of the washcoat (catalyst, catalyst stabilizer, stabilized hexaaluminate, and solvent) on a barium hexaaluminate coated substrate (e.g., stainless steel foil). Within this range, greater than or equal to about 0.1 wt % rhodium is preferred, with greater than or equal to about 2 wt % more preferred. Also preferred within this range is less than or equal to about 10 wt %, with less than or equal to about 4 wt % more preferred. Another preferred catalyst coated substrate comprises, about 10 grams per cubic foot (g/ft³) to about 1,700 g/ft³ rhodium on a lanthanum hexaaluminate coated substrate.

The hexaaluminate coated substrate can comprise, for example, an alumina monolith with a washcoating comprising 90 wt % of the powder comprising of 17 g/ft³ rhodium on lanthanum hexaaluminate and 10 wt % of the powder comprising zirconium oxide. Consequently, the catalyst loading on the hexaaluminate can be about 5 g/ft³ to about 35 g/ft³, with the amount depending upon the type of catalyst employed, the particular fuel to be reformed, and the operating conditions of the reformer.

Deposition of the catalyst can be accomplished by various techniques, including pressurized deposition, vapor deposition, precipitation, dipping, painting, sputtering, spraying, and the like. In order to prevent the degradation of the hexaaluminate scale and to enhance the adhesion of the catalyst to the hexaaluminate, the deposition preferably occurs using a basic solution of the catalyst. Preferably, the catalyst deposition occurs at a pH above the isoelectric point of the hexaaluminate. Although a pH of greater than or equal to about 8 can be employed, a pH of greater than or equal to about 10 is preferred. High pH slurries change the hexaaluminate charge to negative while the precious metal charge remains positive. Also high pH does not dissolve or corrode the ceramic or metal substrates. Basically, precious metal precursors (e.g., the catalyst precursor) dissolved in acid solutions (e.g., a pH of less than about 7) have positive charges. Hexaaluminates and aluminum oxides (e.g., the catalyst stabilizer) in acidic solutions have positive charges. Since both species have a positive charge, there is no electrochemical attraction between the hexaaluminate and the precious metal. Consequently, the precious metal migrates and agglomerates. Such agglomeration leads to low surface area and the resulting low catalytic activity of the catalysts. Furthermore, low pH (e.g., less than or equal to about 4.0) dissolves and corrodes the ceramic and metal substrates.

Once the catalyst precursor is deposited onto the hexaaluminate, it can be reduced to the catalyst metal. Slow reduction is preferred. Oxidized precious metals, for example, are able to rapidly migrate across the support surface into large agglomerates. When the precious metal oxides are reduced to metal, the metals attach to the support surface. If the metals are formed too quickly, they will not have good intimate bonding with the stabilized hexaaluminate. If the metals are formed slowly, they form more intimate bonds, and are more catalytically active. Slow reduction can be accomplished by slow heating of the coated substrate to the desired calcining temperature (e.g., over several hours), or by “step” heating (i.e., heating to a first temperature where substantially all of the solvent (e.g., greater than or equal to about 90 wt % of the solvent is removed), to a second and higher temperature to remove various volatile compounds (e.g., nitrate or the like), and to a third and higher temperature to calcine the coating. These slow reduction processes can take several hours, e.g., up to and exceeding about 5 hours, with about 2.5 to about 3.5 hours common, while producing coatings comprising uniform catalyst loadings (e.g., less than or equal to 5% variation of the catalyst loading across the substrate). In contrast, fast reduction processes can be employed, e.g., heating to calcining temperatures within about 0.5 hours, while producing non-uniform catalyst loadings (e.g., greater than or equal to 10% variation of the catalyst loading across the substrate).

In an exemplary embodiment, a hexaaluminate scale is directly formed on a substrate. Formation directly on the substrate comprises, for example, covering a stainless substrate with molten aluminum intermetallics. When the resulting aluminum intermetallic coated stainless is heated to 1,000° C. in a neutral or reducing atmosphere and then oxidized, stable aluminates are formed.

Crystal stabilizers (such as barium and strontium) can then be implanted onto aluminum coated stainless by disposing the organometallic crystal stabilizer on the aluminates. The alumina substrate and deposited aluminum intermetallic is then annealed (e.g., in hydrogen to react barium and aluminum) at a temperature of about 1,000° C. to about 1,200° C. (to migrate the stabilizers into the aluminum) and then oxidized to form a scale layer of metal-aluminate scale. For example, the stainless substrate can be heated from room temperature (e.g., about 25° C.) to about 1,000° C. in over 1 hour, maintained at 1000° C. for about an 1 hour, cooled to about 600° C. over a period of about 0.5 hour, and then oxygen slowly allowed to react with the aluminum intermetallic to form the hexaaluminate.

Once oxidized, the formed hexaaluminate scale can receive a catalyst (e.g., a precious metal or other reformer catalyst) precursor deposit and then be used as a catalyst in the reformer. This can be accomplished by dipping the hexaaluminate coated substrate into a basic solution of the catalyst precursor, e.g., in a solution of rhodium ammine hydroxide in an ammonium hydroxide solution having a pH of greater than or equal to about 10, forming a precursor coating on the scale. The catalyst precursor is then reduced to the metal. The resulting catalyst coated substrate will maintain a surface area of greater than or equal to about 40 m²/g at temperatures of up to and exceeding about 1,200° C.

Alternatively, once the hexaaluminate has been calcined, preferably to about 1,1 00° C., the hexaaluminate (itself or the hexaaluminate coated substrate) can be doped with the catalyst. Disposing the catalyst on the hexaaluminate is preferably accomplished at a pH above the isoelectric point of hexaaluminate, using organometallics (e.g., solutions of precious metals) or pressurized carbon dioxide deposition (especially employing supercritical carbon dioxide), and employing a slow reduction of the organometallics (as described herein).

In another embodiment, the alumina substrate can receive a washcoat layer that can similarly be used as a reformer. The substrate can be washcoated with a basic pH solution of a catalyst precursor (e.g., a washcoat of hexaaluminate particles), other metal oxide additives, and palladium ammine hydroxide in a solution at a pH of greater than or equal to about 10. The washcoat would then be calcined at about 1,100° C. The resulting coated substrate will maintain a surface area of greater than or equal to about 40 m²/g at temperatures of up to and exceeding about 1,200° C. This coated substrate can be disposed in a housing, with an optional retention material disposed between the housing and the coated substrate, to form a reformer.

In yet another exemplary embodiment, the hexaaluminate powder is formed in a reaction separate from the substrate. For example, the hexaaluminate can be formed by a sol gel technique. According to the sol gel technique, aluminum alkoxides, either alone or in combination with additional metal alkoxides (e.g., isopropoxides of those metals employed as crystal stabilizers above), are mixed in an acidic alcohol solution, such as isopropanol or the like. The solution is hydrolyzed to form a soluble gel. The solution is then calcined up to the temperature at which the final catalyst hexaaluminate will be employed (e.g., for an application that will see be employed at temperatures of up to 1,100° C., the soluble gel is calcined to about 1,100° C.). The calcined hexaaluminate can then be employed to coat the substrate: A specific example of this method includes dissolving aluminum metal with isopropyl alcohol making aluminum isopropoxide. Then, 87 parts aluminum isopropoxide and 13 parts barium isopropoxide are mixed. The mixture is evaporated to a gel. The gel is calcined to 1,100° C.

Once the gel has been formed, it can be deposited on the substrate with the catalyst precursor, either co-deposited or sequentially deposited. Co-deposition can be achieved by mixing the catalyst precursor into the hexaaluminate gel prior to deposition of the gel. In this method, the hexaaluminate gel can act as a binder that holds the metal oxide particles together, surrounding materials such as alkaline oxides, and preventing migration and reaction of alkaline oxides with other active components such palladium oxide, lanthanum oxide, and zirconium oxide. Limiting migration of alkaline oxides, reduces low temperature sintering.

Alternatively, the gel can be deposited on the substrate. Then a catalyst washcoat can be deposited on the substrate as described above. Preferably the washcoat is deposited on the substrate after the hexaaluminate has been calcined. The hexaaluminate layer bonds with the substrate forming a protective coating.

Binders may be added to enhance washcoat adhesion. Washcoat slurries with binders above a pH of 4 are greatly preferred. Soluble aluminum compounds are the most preferred binders. Any soluble inorganic material may become a binder. For example, aluminum nitrate decomposes to aluminum oxide “gluing” the metal oxide powders together. If binders are not added, usually acid or base is added to the washcoat mixture dissolving some of each of the materials. When calcined, those dissolved materials form the ceramic bonds.

As an example of a washcoat for ceramic monoliths, nitric acid and rhodium nitrate are added to a mixture of barium hexaaluminate, lanthanum oxide, zirconium oxide, strontium oxide, and barium oxide. Barium nitrate, aluminum nitrate, lanthanum nitrate, zirconium nitrate and strontium nitrate are formed and in solution. When the washcoat is calcined, barium nitrate forms barium oxide bridging, aluminum nitrate forms aluminum oxide bridging etc. The rhodium nitrate is deposited in the pores of the hexaaluminate particles.

As a second example ammonium hydroxide and palladium ammine hydroxide are added to a mixture of barium hexaaluminate, lanthanum oxide, zirconium oxide, strontium oxide and barium oxide. Barium hydroxide, aluminum hydroxide, lanthanum hydroxide, zirconium hydroxide, strontium hydroxide are formed and in the solution. When the washcoat is calcined, barium hydroxide forms barium oxide bridging, aluminum hydroxide forms aluminum oxide bridging etc.

By way of example only, and not to be limited by the example, where the hexaaluminate can be applied to the substrate, it is possible for several different fractions of hexaaluminate to be applied to a single substrate. One fraction may be made by mixing alkoxides such as aluminum isopropoxide and lanthanum isopropoxide in isopropyl alcohol. Hydrolysis of the mixed metal alkoxides in acidic alcoholic solutions allows for precipitation of the hexaaluminate precursor. The lanthanum hexaaluminate is formed after calcination to at least 500° C. Deposition of a precious metal solution comprising palladium results in a highly dispersed palladium doped lanthanum-hexaaluminate. A second fraction may be made by mixing aluminum isopropoxide and barium isopropoxide, hydrolyzing and calcination. Deposition of a precious metal solution comprising ruthenium results in a highly dispersed ruthenium doped barium hexaaluminate. A third fraction may be made by mixing aluminum isopropoxide and manganese isopropoxide, hydrolyzing and calcination. Deposition of a precious metal solution comprising rhodium results in a highly dispersed rhodium doped barium hexaaluminate. The substrate may then be coated with a formulation containing about 35 weight percent (wt %) to about 65 wt % rhodium doped lanthanum hexaaluminate, containing less than or equal to about 35 wt % ruthenium doped barium hexaaluminate, and containing less than or equal to about 35 wt % rhodium doped manganese hexaaluminate.

### EXAMPLES

### Example 1

A cordierite monolith was coated with 7.0 g/in³ slurry containing solids of barium hexaaluminate containing 0.25 wt % rhodium nitrate. The monolith/washcoat was calcined at 500° C. for 4 hours. The dried and calcined monolith had a washcoat of 4.0 g/in³ barium hexaaluminate and 22 g/ft³ rhodium. The barium hexaaluminate had a surface area of 94 m²/g. (Similar results were obtained employing zirconium toughened aluminum oxide and metal monoliths.)

### Example 2

A metal monolith was coated with 7.0 g/in³ slurry containing solids of 87.2 wt % barium hexaaluminate, 4 wt % barium oxide, 3 wt % strontium oxide, 3 wt % lanthanum oxide, 2 wt % zirconium oxide and 0.8 wt % rhodium ammine hydroxide. The monolith with washcoat was calcined at 500° C. for 4 hours. The finished monolith had a washcoat of 3.52 g/in³ barium hexaaluminate, 0.16 g/in³ barium oxide, 0.12 g/in³ strontium oxide, 0.12 g/in³ lanthanum oxide, 0.08 g/in³ zirconium oxide and 22 g/ft³ rhodium. The barium hexaaluminate with zirconia stabilizers and palladium had a surface area of 127 m²/g.

### Example 3

A metal monolith was coated with 7.0 g/in³ slurry containing solids of 45.5 wt % barium hexaaluminate, 44.7 wt % lanthanum hexaaluminate, 4 wt % barium oxide, 3 wt % strontium oxide, 2 wt % zirconium oxide, 0.8 wt % ruthenium nitrate. The monolith with washcoat was calcined at 500° C. for 4 hours. The finished monolith had a washcoat of 3.52 g/in³ barium hexaaluminate, 0.16 g/in³ barium oxide, 0.12 g/in³ strontium oxide, 0.12 g/in³ lanthanum oxide, 0.08 g/in³ zirconium oxide, 35 g/ft³ ruthenium. The barium hexaaluminate and lanthanum hexaaluminate with zirconia stabilizers and ruthenium had a surface area of 138 m²/g.

### Example 4

A metal monolith was coated with 7.0 g/in³ slurry containing solids of 90.2 wt % praseodymium-manganese hexaaluminate, 4 wt % barium oxide, 3 wt % strontium oxide, 2 wt % zirconium oxide, 0.8 wt % rhodium ammine hydroxide. The monolith with washcoat was calcined at 500° C. for 4 hours. The finished monolith had a washcoat of 3.52 g/in³ barium hexaaluminate, 0.16 g/in³ barium oxide, 0.12 g/in³ strontium oxide, 0.12 g/in³ lanthanum oxide, 0.08 g/in³ zirconium oxide and 35 g/ft³ rhodium. The manganese hexaaluminate with zirconia stabilizers and rhodium had a surface area of 83 m²/g.

### Example 5

Barium hexaaluminate powder was doped with rhodium ammine hydroxide and calcined at 500° C. for 4 hours. A 0.04 wt % loading of rhodium was obtained after calcination. A zirconia toughened alumina monolith was coated with a zirconium phosphate solution then calcined at 500° C. for 4 hours. The metal monolith with zirconium phosphate layer was coated with 7.0 g/in³ slurry containing solids of 45.5 wt % rhodium doped barium hexaaluminate, 44.7 wt % rhodium doped lanthanum hexaaluminate, 4 wt % barium oxide, 3 wt % strontium oxide, 2 wt % potassium oxide and 2 wt % zirconium oxide. The monolith with washcoat was calcined at 500° C. for 4 hours. The finished monolith had a washcoat of 3.52 g/in³ barium hexaaluminate, 0.16 g/in³ barium oxide, 0.12 g/in³ strontium oxide, 0.12 g/in³ lanthanum oxide, 0.08 g/in³ zirconium oxide and 4.0 wt % rhodium. The mixture of barium hexaaluminate-rhodium and lanthanum hexaaluminate-palladium had a surface area of 105 m²/g.

### Example 6

One fraction was made by mixing aluminum isopropoxide, barium isopropoxide, and lanthanum isopropoxide in isopropyl alcohol. Hydrolysis of the metal alkoxides in acidic alcoholic solution allows lanthanum-barium-hexaaluminate formation. The formed hexaaluminate was calcined at 1,100° C. Rhodium 2-ethyl hexanoate is deposited by supercritical carbon dioxide deposition. Hexaaluminate powder and rhodium 2-ethylhexanoate are placed within a pressure chamber and pressurized. Supercritical carbon dioxide was introduced into the pressure chamber and the rhodium 2-ethylhexanoate was dissolved in the supercritical carbon dioxide. The supercritical carbon dioxide-rhodium 2-ethylhexanoate was maintained in contact with the hexaaluminate powder while the pressure was increased up to 36,000 psi. The rhodium 2-ethylhexanoate was even deposited into the finest hexaaluminate pores. The pressure chamber was then slowly vented, thereby slowly removing the carbon dioxide and leaving the rhodium 2-ethylhexanoate as a residue in the hexaaluminate powder porosity. Subsequent calcination at 1,100° C. resulted in very well dispersed rhodium metal on hexaaluminate powder (i.e., the rhodium particles were below 2 nanometers (nm); the detection limits of Transmission Electron Microscopy (TEM).

A second fraction was made by mixing aluminum isopropoxide and manganese isopropoxide in isopropyl alcohol. Hydrolysis, accomplished by the addition of up to one mole water for each mole of manganese isopropoxide and aluminum isopropoxide, formed a gel. The gel was heated to about 110° C. to remove volatile components and to yield a solid. The solid was calcined at 1,100° C., resulting in manganese-hexaaluminate formation. A silicon carbide foam with 20 pores per square inch (ppsi) was coated with the formulation containing 68 wt % rhodium/bariumlanthanum hexaaluminate and 32 wt % manganese hexaaluminate.

### Example 7

About 2 wt % to about 4 wt % aluminum phosphate can be added as a hardening agent to about 96 wt % to about 98 wt % manganese hexaaluminate, based upon the combined weight of the aluminum phosphate and the manganese hexaaluminate. A slurry containing about 58% solids can be poured over a polyurethane foam (an organic foam material). The foam is then burned off at about 500° C. to about 700° C. to form a manganese hexaaluminate foam substrate. The substrate can be impregnated with a water solution of rhodium hexaammine nitrate with a rhodium loading that is preferably about 1.0 wt %. The rhodium-hexaammine doped metal-hexaaluminate can be dried and then calcined at about 500° C. for at least about 2 hours.

### Example 8

About 2 wt % to about 4 wt % aluminum phosphate, about 2 wt % to about 4 wt % methylcellulose, about 16 wt % to about 28 wt % kaolin, and less than or equal to about 80 wt % barium hexaaluminate (based upon the total weight of these combined ingredients) can be made into an extrudable paste. The paste can be extruded into a monolithic form containing, for example, 400 cells per square inch. The monolith can be dried and then calcined at about 1,100° C. for about 4 hours or so. The substrate can then be impregnated with a water solution of rhodium hexaammine nitrate preferably having a rhodium loading of 1.0 wt %. The rhodiumhexaammine doped metal-hexaaluminate can be dried and then calcined at about 500° C. for at least about 2 hours.

Most vehicles emit enough hydrocarbons before the exhaust catalysts are active to fail super low emission vehicle (SULEV) requirements. A vehicle can be started on hydrogen. A vehicle started with hydrogen has no hydrocarbon emissions. After the exhaust catalysts reach lightoff, vehicle fueling can be switched from hydrogen to gasoline or diesel. A vehicle started with hydrogen and switched to gasoline or diesel after exhaust catalyst lightoff can achieve the SULEV emission standards.

A close coupled catalyst combusting unburnt hydrocarbons from the engine may take 30 seconds or longer to reach lightoff temperatures. During the 30 seconds before lightoff, enough hydrocarbons are emitted to exceed SULEV emissions. Hydrogen can be injected into the exhaust directly upstream of the lightoff catalyst. The lightoff catalyst combusting hydrogen can reach lightoff temperatures in 5 seconds or less. After catalyst lightoff the hydrogen injection can be terminated. A vehicle system with hydrogen injection into the exhaust for the first 7 seconds after starting can achieve the SULEV emission standards.

Existing vehicles utilize unburnt hydrocarbons as the reductant for nitrogen oxide. If not enough hydrocarbons are present, SULEV hydrocarbon emissions are met, but SULEV nitrogen oxide levels are exceeded. If excess hydrocarbon is used, SULEV nitrogen oxide emissions are met but SULEV hydrocarbon levels are exceeded. Hydrogen can reduce nitrogen oxide without increasing hydrocarbon emissions. An exhaust system utilizing hydrogen injection can attain emissions below SULEV nitrogen oxide and below SULEV hydrocarbon standards.

The use of a hexaaluminate as a catalyst, particularly as a catalyst in an exhaust emission control device has several advantages. One such advantage is that the hexaaluminate can avoid sintering at higher temperatures than can aluminum oxide, thereby enhancing resistance of the catalyst and monolithic support and increasing the durability of the reformer. An additional advantage is that lesser amounts of precious metal oxides need be deposited onto the hexaaluminate, while retaining similar activity. In an aluminum oxide catalytic reformer, about 2 wt % to about 5 wt % of rhodium metal is employed with a typical loading of 3 wt % for an aluminum oxide washcoat (e.g., to have sufficient activity to reduce one or more of the exhaust gas components to a desired level). Where an aluminum oxide enhanced with barium or lanthanum is employed, a precious metal oxide loading of about 1 wt % to about 3 wt % is employed to attain a similar activity with typical loading of 2 wt % for a barium stabilized aluminum oxide washcoat. In contrast, when a hexaaluminate is employed, with one or more stabilizers a precious metal oxide loading of about 0.5 wt % to about 2.0 wt % is employed to attain a similar activity with typical loading of 0.75 wt % for a barium hexaaluminate washcoat.

Precious metal reductions are possible because the hexaaluminate is less prone to sintering than are alumina's or stabilized alumina's. The precious metal is less likely to be trapped in the collapsed pores of hexaaluminates. Also, the stabilizers prevent migration of precious metal oxides. Therefore, less precious metal oxides can be employed, while attaining similar activity. The reduction in the catalyst loading enables a significant cost reduction in the production of the reformer. Preferably, rhodium loadings of about 0.1 wt % to about 2 wt % will be employed. Within this range, loadings of less than or equal to about 1 wt % are preferred, with less than or equal to about 0.75 wt % more preferred, and less than or equal to about 0.5 wt % especially preferred.

Additionally, an aluminum oxide without stabilizer(s) in the crystalline structure exposed to a temperature of less than 1,050° C. has a surface area of about 100 square meters per gram (m²/g) to about 120 m²/g. When exposed to temperatures of 1,050° C., however, the surface area decreases to about 20 m²/g. In contrast, a hexaaluminate comprising a stabilizer such as, barium or lanthanum, in the crystalline structure, retains a surface area of about 100 m²/g at temperatures of less than or equal to about 1,350° C. Additionally, at temperatures of less than and equal to about 1,600° C., a surface area of greater than or equal to about 30 m²/g is retained, with greater than or equal to about 40 m²/g possible.

Aluminum isopropoxide and barium isopropoxide solutions mixed and co-fired have surface area of 150 meters squared per gram up to 1,300° C. Aluminum oxide from aluminum isopropoxide, with no barium present, has surface area of 150 meters squared per gram only up to about 960° C. Aluminum oxide from aluminum isopropoxide, in the presence of barium oxide has surface area of 150 meters squared per gram only up to temperatures of about 880° C.

A significant amount (e.g., greater than about 10%) of catalytic reformers may have to be replaced due to low catalyst activity by 50,000 vehicle starts, i.e., insufficient activity to meet SULEV. A thermally stable oxide support is needed. Considering that the problems of the loss of the alumina support are eliminated, it is believed that, in contrast, the reformer comprising the stabilized hexaaluminate maintains a sufficient catalyst activity to at least meet SULEV for greater than or equal to about 100,000 vehicle starts, with greater than or equal to about 150,000 vehicle starts believed readily achievable.

Yet another advantage of employing a hexaaluminate as the substrate or as a support for the catalyst on the substrate, is reduction of free ions. Catalysts containing free ions, e.g., barium, facilitate the migration of the catalyst, especially precious metals. The precious metals agglomerate, substantially reducing activity or rendering them inactive. Since the hexaaluminate incorporates the ions (e.g., as the crystal stabilizer) into the crystalline structure, the ions are not free to migrate or to induce the migration of the precious metals. Consequently, the life of the catalyst is increased.

The reformer comprising the crystal stabilized hexaaluminate and the reforming catalyst can be employed in various systems and can be used in various methods. The systems can comprise a device (e.g., an engine (such as, gasoline or diesel), and/or a fuel cell, that can be in operable communication with a transmission), and optionally an exhaust emission control device. The reformer can be disposed in fluid communication with the fuel cell, engine fuel injectors, and/or with the exhaust emission control device. During use, hydrogen produced in the reformer can be directed to the fuel injectors, to the fuel cell, and/or to the exhaust emission control device. The use of this hydrogen, particularly during startup enables the system to be rapidly started-up (e.g., reach light off (a point where the particular device is operating at 50% efficiency) in less than or equal to about 10 seconds) while meeting SULEV emission standards. Attaining light-off in less than or equal to about 7 seconds is readily attained.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A system, comprising:
a device selected from the group consisting of an engine, a fuel cell, and combinations thereof; and
a reformer disposed in fluid communication with the device, the reformer comprising a housing and a support disposed within the housing, wherein the support comprises a reforming catalyst and a hexaaluminate comprising a crystal stabilizer disposed in a hexaaluminate crystal structure.

2. The system of claim 1, wherein the reformer further comprises a ceramic foam substrate.

3. The system of claim 1, wherein the reforming catalyst is selected from the group consisting of platinum, palladium, rhodium, ruthenium, gold, silver, and combinations comprising one or more of these catalysts.

4. The system of claim 1, wherein the crystal stabilizer is selected from the group consisting of barium, strontium, lanthanum, praseodymium, manganese, platinum, palladium, rhodium, ruthenium, gold, silver, manganese, iron, cobalt, nickel, and combinations comprising one or more of the foregoing catalyst stabilizers.

5. The system of claim 4, wherein the crystal stabilizer is selected from the group consisting of barium, lanthanum, strontium, ruthenium, and combinations comprising one or more of the foregoing crystal stabilizers.

6. The system of claim 1, wherein the support further comprises a catalyst stabilizer disposed in grain boundaries, wherein the catalyst stabilizer is selected from the group consisting of lithium, sodium, potassium, rubidium, strontium, barium, haffium, scandium, zirconium, yttrium, cerium, lanthanum, praseodymium, aluminum, neodymium, and combinations comprising one or more of the foregoing catalyst stabilizers.

7. The system of claim 6, wherein the catalyst stabilizer is selected from the group consisting of barium-zirconium oxide, barium aluminate, and combinations comprising one or more of the foregoing catalyst stabilizers.

8. The system of claim 1, wherein the support further comprises a substrate selected from the group consisting of cordierite, silicon carbide, alumina, aluminum, ferrous material, glass, and combinations comprising one or more of the foregoing substrates.

9. The system of claim 1, wherein the engine and the fuel cell are in operable communication with a transmission.

10. The system of claim 1, wherein the reformer is in fluid communication with an exhaust conduit in fluid communication with an outlet of the engine.

11. The system of claim 10, further comprising a close coupled exhaust emission treatment device disposed in fluid communication with and downstream of the reformer.

12. The system of claim 11, wherein the reformer is in fluid communication with a fuel injector in the engine.

13. The system of claim 1, wherein the reformer is in fluid communication with a fuel injector in the engine.

14. A reformer, comprising:
a housing and a support disposed within the housing, wherein the support comprises a reforming catalyst and a hexaaluminate comprising a crystal stabilizer disposed in a hexaaluminate crystal structure.

15. The reformer of claim 14, wherein the reforming catalyst is selected from the group consisting of platinum, palladium, rhodium, ruthenium, gold, silver, and combinations comprising one or more of these catalysts.

16. The reformer of claim 15, wherein the crystal stabilizer is selected from the group consisting of barium, strontium, lanthanum, praseodymium, manganese, platinum, palladium, rhodium, ruthenium, gold, silver, manganese, iron, cobalt, nickel, and combinations comprising one or more of the foregoing catalyst stabilizers.

17. The reformer of claim 14, wherein the support further comprises a catalyst stabilizer disposed in grain boundaries, wherein the catalyst stabilizer is selected from the group consisting of lithium, sodium, potassium, rubidium, strontium, barium, hafnium, scandium, zirconium, yttrium, cerium, lanthanum, praseodymium, aluminum, neodymium, and combinations comprising one or more of the foregoing catalyst stabilizers.

18. The reformer of claim 17, wherein the support further comprises a substrate selected from the group consisting of cordierite, silicon carbide, metal, alumina, aluminum, ferrous material, glass, and alloys and combinations comprising one or more of the foregoing substrates.

19. A method for reforming a fuel, comprising:
directing fuel into a reformer comprising a housing and a support disposed within the housing, the support comprising a reforming catalyst and a hexaaluminate comprising a crystal stabilizer disposed in a hexaaluminate crystalline structure; and
reforming at least a portion of the fuel.

20. The method for reforming of claim 19, wherein the reforming catalyst is selected from the group consisting of platinum, palladium, rhodium, ruthenium, iridium, gold, silver, and combinations comprising one or more of these catalysts.

21. A method for operating a vehicle, comprising:
starting an engine;
directing fuel to a reformer to produce hydrogen, wherein the reformer comprises a housing and a support disposed within the housing, the support comprising a reforming catalyst and a hexaaluminate comprising a crystal stabilizer disposed in a hexaaluminate crystalline structure; and
directing at least a first portion of the hydrogen to an exhaust emission control device.

22. The method for operating a vehicle of claim 21, further comprising:
directing a second portion of the hydrogen to a fuel injector in the engine;
monitoring the temperature of the engine;
ceasing directing the second portion of the hydrogen to the engine when the engine attains a selected temperature; and
ceasing directing the first portion of the hydrogen to the exhaust emission control device when the exhaust emission control device attains a light-off temperature.

23. The method for operating a system, comprising:
directing fuel to a reformer to produce hydrogen, wherein the reformer comprises a housing and a support disposed within the housing, the support comprising a reforming catalyst and a hexaaluminate comprising a crystal stabilizer disposed in a hexaaluminate crystalline structure; and
directing at least a first portion of the hydrogen to a fuel cell.

24. The method for operating a system of claim 23, further comprising directing a second portion of the hydrogen to a fuel injector in an engine.

25. The method for operating a system of claim 24, further comprising directing a third portion of the hydrogen to an exhaust emission control device.

26. The method for operating a system of claim 23, further comprising directing a third portion of the hydrogen to an exhaust emission control device.
